(19) United States
(12) Patent Application Publication
(10) Pub. No.: US 2016/0216551 A1
(43) Pub. Date: Jul. 28, 2016

(54) NORMALLY WHITE TYPE LIQUID CRYSTAL DISPLAY DEVICE

(71) Applicant: TRULY SEMICONDUCTORS LTD., Guangdong (CN)

(72) Inventors: Junwen Hu, Shanwei, Guangdong (CN); Lin Li, Shanwei, Guangdong (CN); Shengbao Hong, Shanwei, Guangdong (CN); Xueyong Huang, Shanwei, Guangdong (CN); Jiqiang He, Shanwei, Guangdong (CN)

(21) Appl. No.: 14/896,563

(22) PCT Filed: Aug. 27, 2013
(86) PCT No.: PCT/CN2013/082340

§ 371 Date: Mar. 15, 2016

(30) Foreign Application Priority Data
Jun. 9, 2013 (CN) 201310231661.0

(51) Int. Cl. G02F 1/1335

(52) U.S. Cl. CPC G02F 1/133512; G02F 1/133528

(57) ABSTRACT

A normally white type liquid crystal display device comprises a liquid crystal display, a backlight source and a dimmer film. The dimmer film is located on one surface, far away from the backlight, of the liquid crystal display, or in the liquid crystal display, or between the liquid crystal display and the backlight source, or in the backlight source. Under the circumstances that a voltage is not applied between an upper polarizer and a lower polarizer of the normally white type liquid crystal display device and a voltage is not applied to the backlight source, the transmittance of incident light and reflected light is reduced due to the existence of the dimmer film.

The present application claims the priority to Chinese Patent Application No. 201310231661.0, titled “NORMALLY WHITE LIQUID CRYSTAL DISPLAY DEVICE”, filed on Jun. 9, 2013 with the State Intellectual Property Office of People's Republic of China, the content of which is incorporated herein by reference.

### FIELD

The present disclosure relates to the technical field of liquid crystal display, and in particular to a normally white liquid crystal display device.

### BACKGROUND

A liquid crystal display device includes a normally black liquid crystal display device and a normally white liquid crystal display device. The normally black liquid crystal display device is referred to as an NB (Normally Black) liquid crystal device for short. An upper polarizer and a lower polarizer of the NB liquid crystal device have parallel polarities, hence the liquid crystal is opaque and the display screen is dark in a case that no voltage is applied between the upper polarizer and the lower polarizer; and the liquid crystal can transmit light and the display screen is bright in a case that voltage is applied between the upper polarizer and the lower polarizer. The normally white liquid crystal display device is referred to as an NW (Normally White) liquid crystal device for short. Since an upper polarizer and a lower polarizer of the NW liquid crystal device have perpendicular polarities, hence the liquid crystal can transmit light and the display screen is bright in a case that no voltage is applied between the upper polarizer and the lower polarizer; or the liquid crystal is opaque and the display screen is dark in a case that voltage is applied between the upper polarizer and the lower polarizer.

Reference is made to FIG. 1 which shows a schematic structural diagram of a normally white liquid crystal display device. The normally white liquid crystal display device includes a liquid crystal display and a backlight source, and the liquid crystal display is arranged above the backlight source. The liquid crystal display includes: an upper polarizer 1, a Color Filter (CF) substrate 2 arranged below the upper polarizer 1, a liquid crystal cell 3 arranged below the CF substrate 2, a thin film transistor array (TFT) substrate 4 arranged below the liquid crystal cell 3 and a lower polarizer 5 arranged below the TFT substrate 4. The backlight source includes: a diffuser plate 6 arranged below the lower polarizer 5, a light guide plate 7 arranged below the diffuser plate 6 and a reflection layer 8 arranged below the light guide plate 7. The upper polarizer and the lower polarizer have the same structure. As shown in FIG. 2, the upper polarizer and the lower polarizer each include: a protective film 21, a first Triacetyl Cellulose (TAC) film 22 arranged below the protective film 21, a PolyvinylAlcohol (PVA) film 23 arranged below the first TAC film 22, a second TAC film 24 arranged below the PVA film 23, a pressure-sensitive layer 25 arranged below the second TAC film 24 and a release film 26 arranged below the pressure-sensitive layer 25.

Presently, most of the conventional liquid crystal display devices are normally white liquid crystal display devices. For example, a normally white liquid crystal display device is applied to a desktop computer or a notebook computer. Since a majority part of a whole screen presents luminous points and the screen displays with a white background and black words in case of running software by a computer. Since a majority part of a whole screen presents luminous points, the use of the normally white liquid crystal display device is convenient, and no voltage is to be applied to the luminous points on the normally white liquid crystal display device, and thereby saving electrical power. However, in a case that no voltage is applied on the backlight source of the normally white liquid crystal display device and no voltage is applied between the upper polarizer and the lower polarizer of the normally white liquid crystal display device, i.e., the normally white liquid crystal display device does not operate, a large portion of incident natural light will be reflected, and thereby irritating an eye and causing a user to feel dazzling.

### SUMMARY

In view of the above, a normally white liquid crystal display device is provided according to the present disclosure, which efficiently reduces dazzling.

In order to achieve the above object, technical solutions of the present disclosure are provided hereinafter.

A normally white liquid crystal display device including a liquid crystal display and a backlight source is provided, where the normally white liquid crystal display device further includes a light-reducing film, and the light-reducing film is arranged on a surface of the liquid crystal display facing away from the backlight source, inside the liquid crystal display, between the liquid crystal display and the backlight source, or inside the backlight source.

Preferably, the light-reducing film being arranged inside the liquid crystal display may include: the light-reducing film being arranged inside an upper polarizer, between the upper polarizer and a CF substrate, between the CF substrate and a liquid crystal cell, between the liquid crystal cell and a TFT substrate, between the TFT substrate and a lower polarizer or inside the lower polarizer.

Preferably, the light-reducing film may have a thickness of 0.1 μm-20 μm, inclusive of 0.1 μm and 20 μm, in a case that the light-reducing film is arranged on the surface of the liquid crystal display facing away from the backlight source, between the upper polarizer and the CF substrate, between the CF substrate and the liquid crystal cell, between the liquid crystal cell and the TFT substrate, between the TFT substrate and the lower polarizer or between the liquid crystal display and the backlight source.

Preferably, the light-reducing film may have a thickness of 0.01 mm-0.50 mm, inclusive of 0.01 mm and 0.50 mm, in a case that the light-reducing film is arranged inside the upper polarizer, inside the lower polarizer or inside the backlight source.

Preferably, the light-reducing film may have a thickness of 0.1 mm.

Preferably, the light-reducing film being arranged inside the upper polarizer may include: the light-reducing film being arranged between a protective film and a first TAC film of the upper polarizer, between the first TAC film and a PVA film of the upper polarizer, between the PVA film and a second TAC film of the upper polarizer, between the second TAC film and a pressure-sensitive layer of the upper polarizer or between the pressure-sensitive layer and a release film of the upper polarizer.

Preferably, the light-reducing film being arranged inside the lower polarizer may include: the light-reducing film being arranged between a protective film and a first TAC film of the lower polarizer, between the first TAC film and a PVA film of the lower polarizer, between the PVA film and a second TAC film of the lower polarizer, between the second TAC film and a pressure-sensitive layer of the lower polarizer or between the pressure-sensitive layer and a release film of the lower polarizer.

Preferably, the light-reducing film being arranged inside the backlight source may include: the light-reducing film being arranged between a diffuser plate and a light guide plate of the backlight source or between the light guide plate and a reflection layer of the backlight source.

Preferably, the light-reducing film may have a light transmittance of 10%-90%, inclusive of 10% and 90%.

Preferably, the light-reducing film may be a black resin film or a gray resin film.

As compared with the conventional technology, the technical solutions according to the present disclosure have the following advantages.

The normally white liquid crystal display device according to the present disclosure has a light-reducing film. In a case that no voltage is applied between the upper polarizer and the lower polarizer of the normally white liquid crystal display device and no voltage is applied on the backlight source of the normally white liquid crystal display device, a part of incident natural light is absorbed by the light-reducing film when passing through the light-reducing film. Another part of the natural light is absorbed when the natural light is reflected by the reflection layer and passes through the light-reducing film again. The intensity of the natural light, which becomes emergent light now, is reduced efficiently, and thereby reducing the dazzling caused by the conventional normally white liquid crystal display device.

In addition, since the light transmittance of the incident light and the reflected light is reduced, a display background color of the normally white liquid crystal display device tends to change from gray to black, such that the normally white liquid crystal display device looks beautiful and is easier to be accepted by most of people, and thereby broadening an application range of the normally white liquid crystal display device.

### BRIEF DESCRIPTION OF THE DRAWINGS

In order to illustrate technical solutions in embodiments of the present disclosure or the conventional technology more clearly, hereinafter drawings to be used in the description of the embodiments or the conventional technology are introduced simply. Apparently, the drawings described below only describe some embodiments of the present disclosure, and other drawings may be obtained based on these drawings by those skilled in the art without any creative work.

FIG. 1 is a schematic structural diagram of a normally white liquid crystal display device according to the conventional technology;

FIG. 2 is a schematic structural diagram of an upper polarizer or lower polarizer; and

FIG. 3a to FIG. 3j are schematic diagrams illustrating positions where a light-reducing film may be arranged according to an embodiment.

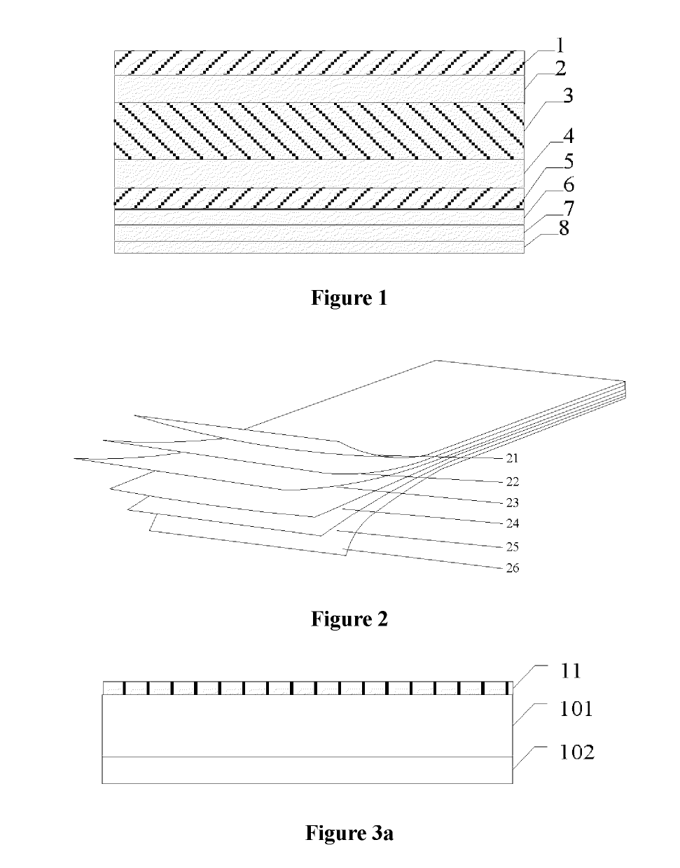

### DETAILED DESCRIPTION OF THE EMBODIMENTS

As described in the background, in a case that no voltage is applied on a backlight source of a normally white liquid crystal display device and no voltage is applied between an upper polarizer and a lower polarizer of the normally white liquid crystal display device, a large amount of light is reflected from the normally white liquid crystal display device, and thereby irritating an eye and causing a user to feel dazzling.

It is found by the inventor that in the case that no voltage is applied on the backlight source of the normally white liquid crystal display device and no voltage is applied between the upper polarizer and the lower polarizer of the normally white liquid crystal display device, when natural light transmitted by the liquid crystal display device reaches the reflection layer of the backlight source, a large amount of the natural light will be reflected by the reflection layer of the backlight source, which causes the above described deficiency, and thereby irritating an eye and causing a user to feel dazzling.

In addition, in the case that no voltage is applied on the backlight source of the normally white liquid crystal display device and no voltage is applied between the upper polarizer and the lower polarizer of the normally white liquid crystal display device, the display background color of the normally white liquid crystal display device is gray and is not beautiful.

In view of the above, a normally white liquid crystal display device is provided according to the present disclosure, which includes a liquid crystal display and a backlight source. The normally white liquid crystal display device further includes a light-reducing film, and the light-reducing film is arranged on a surface of the liquid crystal display facing away from the backlight source, inside the liquid crystal display, between the liquid crystal display and the backlight source or inside the backlight source.

The normally white liquid crystal display device according to the present disclosure has a light-reducing film. In a case that no voltage is applied between the upper polarizer and the lower polarizer of the normally white liquid crystal display device and no voltage is applied on the backlight source of the normally white liquid crystal display device, a part of incident natural light is absorbed by the light-reducing film when passing through the light-reducing film. Another part of the natural light is absorbed when the natural light is reflected by the reflection layer and passes through the light-reducing film again. The intensity of the natural light, which becomes emergent light now, is reduced efficiently, and thereby reducing the dazzling caused by the conventional normally white liquid crystal display device.

In addition, since the light transmittance of the incident light and the reflected light is reduced, a display background color of the normally white liquid crystal display device tends to change from gray to black, such that the normally white liquid crystal display device looks beautiful and is easier to be accepted by most of people, and thereby broadening an application range of the normally white liquid crystal display device.

The concept of the present disclosure is described above. In order to make the objects, features and advantages above of the present disclosure more obvious and easier to be understood, hereinafter specific implementations of the present disclosure are described in detail in conjunction with the drawings.

In order to understand the present disclosure fully, many specific details are clarified in the following description and the present disclosure may be implemented by other ways different from that described here. Those skilled in the art may extend the embodiments without departing from the connotation of the present disclosure, and hence the present disclosure is not limited by the disclosed specific embodiments hereinafter.

In addition, the present disclosure is described in detail in conjunction with schematic diagrams. In the detailed description of the present disclosure, in order to illustrate, a schematic diagram indicating the device structure is amplified partially with a proportion different from a general proportion, and the schematic diagram is only illustrative and is not intended to limit the scope of protection of the present disclosure. Furthermore, a three-dimensional spatial size including a length, a width and a depth is considered during a practical fabrication process.

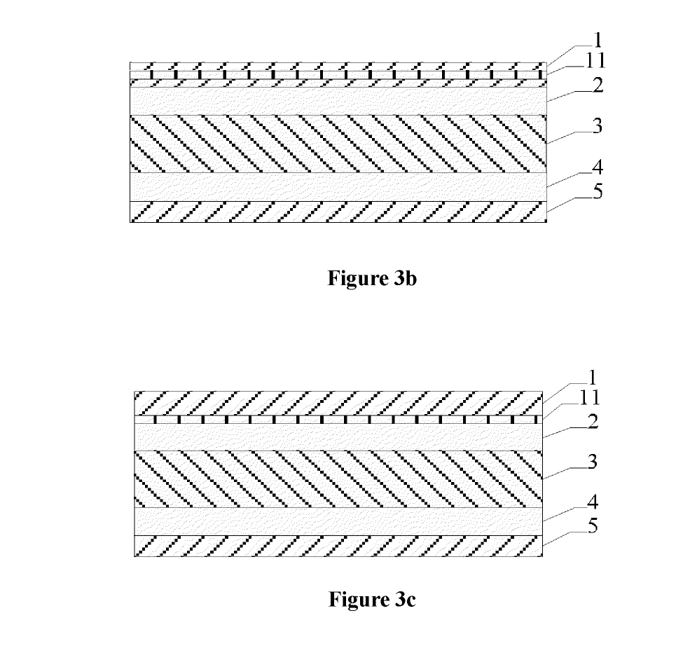

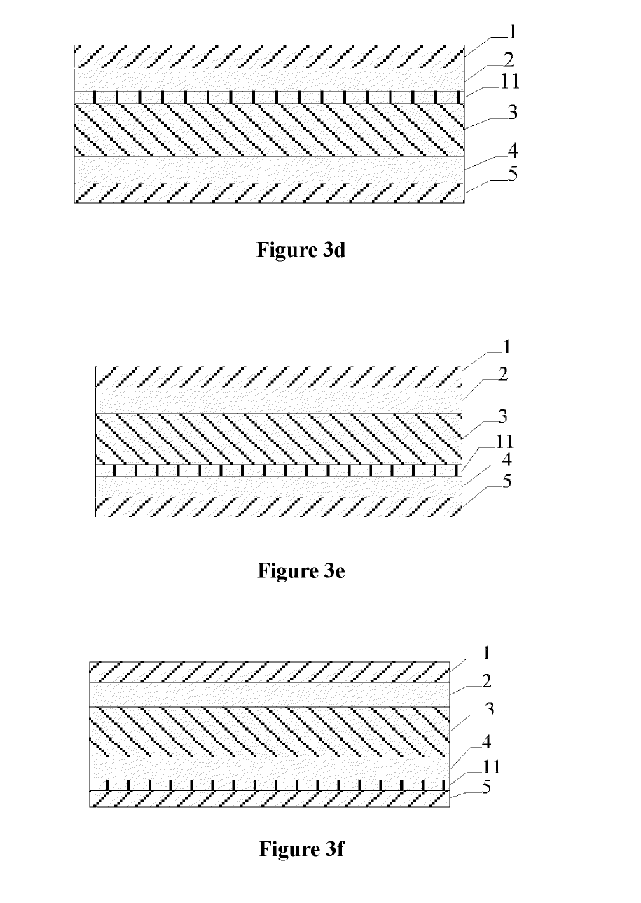

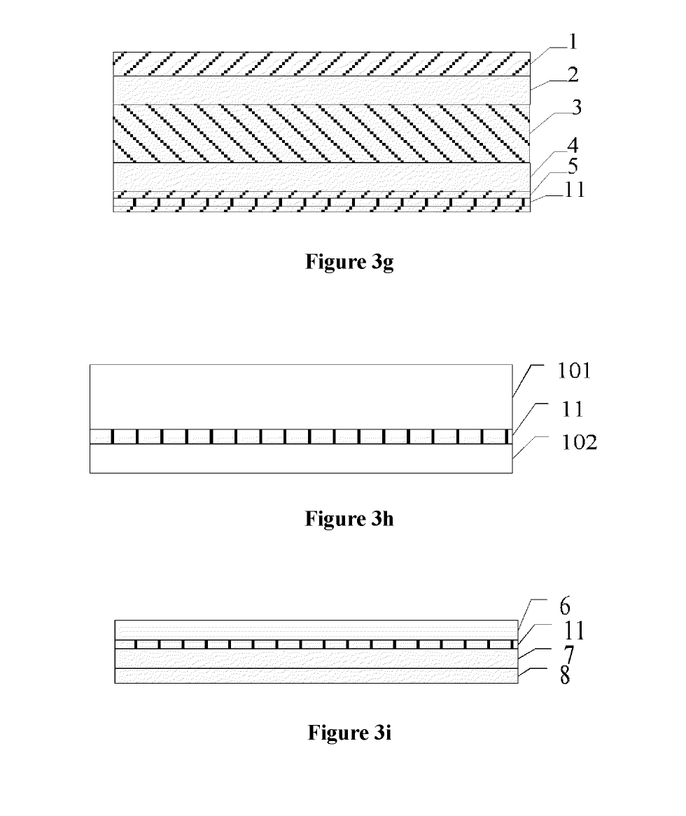

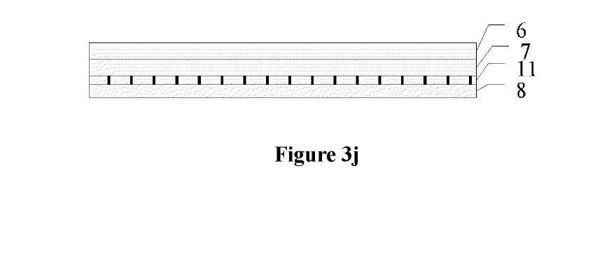

A normally white liquid crystal display device is provided according to an embodiment of the present disclosure, and the embodiment is described in conjunction with FIG. 3a to FIG. 3i.

The normally white liquid crystal display device includes a liquid crystal display, a backlight source and a light-reducing film. The light-reducing film is arranged on a surface of the liquid crystal display facing away from the backlight source, inside the liquid crystal display, between the liquid crystal display and the backlight source or inside the backlight source.

In the embodiment, preferably the light-reducing film has a light transmittance of 10%-90%, inclusive. For example, in a case that the light-reducing film has a light transmittance of 80%, an incident light is divided into 100 portions. In a case that no voltage is applied between an upper polarizer and a lower polarizer of the liquid crystal display and no voltage is applied on the backlight source, 100 portions of the incident light enters the normally white liquid crystal display device, 80 portions of the incident light reaches a reflection layer after passing through the light-reducing film, and 64 portions of the light are left after the light is reflected by the reflection layer and passes through the light-reducing film again, and thereby reducing the dazzling. In a case a voltage is applied between the upper polarizer and the lower polarizer and applied on the backlight source, light emitted from the backlight source only passes through the light-reducing film once, and thereby causing a little influence on display brightness. The light-reducing film is a dark transparent film. The light-reducing film is a black resin film or a gray resin film.

The liquid crystal display includes an upper polarizer 1, a CF substrate 2, a liquid crystal cell 3, a TFT substrate 4 and a lower polarizer 5. The backlight source includes a diffuser plate 6, a light guide plate 7 and a reflection layer 8.

As shown in FIG. 3a to FIG. 3h respectively, the light-reducing film 11 is arranged on a surface of the liquid crystal display 101 facing away from the backlight source 102, inside the upper polarizer 1, between the upper polarizer 1 and the CF substrate 2, between the CF substrate 2 and the liquid crystal cell 3, between the liquid crystal cell 3 and the TFT substrate 4, between the TFT substrate 4 and the lower polarizer 5, inside the lower polarizer 5 or between the liquid crystal display 101 and the backlight source 102.

In the embodiment, preferably the light-reducing film has a thickness of 0.1 μm-20 μm, inclusive, and more preferably the light-reducing film has a thickness of 1 μm-2 μm, inclusive, in a case that the light-reducing film is arranged on the surface of the liquid crystal display facing away from the backlight source, between the upper polarizer and the CF substrate, between the CF substrate and the liquid crystal cell, between the liquid crystal cell and the TFT substrate, between the TFT substrate and the lower polarizer or between the liquid crystal display and the backlight source. The light-reducing film has a thickness of 0.01 mm-0.50 mm, inclusive, in a case that the light-reducing film is arranged inside the upper polarizer, inside the lower polarizer or inside the backlight source. Preferably, the light-reducing film has a thickness of 0.1 mm. The light-reducing film may be arranged at one of these different positions, the light-reducing film may be adjusted to have the most appropriate thickness and density, and the light transmittance of the light-reducing film may be adjusted. Thus, the internal structure of the liquid crystal display is not influenced; in addition, in a case that the normally white liquid crystal display device does not operate, i.e., no voltage is applied between the upper polarizer and the lower polarizer and applied on the backlight source, the light transmittance of incident natural light and the light transmittance of the natural light reflected from the liquid crystal display device are reduced, and thereby efficiently reducing the dazzling.

The light-reducing film is arranged inside the upper polarizer. The light-reducing film being arranged inside the upper polarizer may include: the light-reducing film being arranged between a protective film and a first TAC film of the upper polarizer, between the first TAC film and a PVA film of the upper polarizer, between the PVA film and a second TAC film of the upper polarizer, between the second TAC film and a pressure-sensitive layer of the upper polarizer or between the pressure-sensitive layer and a release film of the upper polarizer.

The light-reducing film being arranged inside the lower polarizer may include: the light-reducing film being arranged between a protective film and a first TAC film of the lower polarizer, between the first TAC film and a PVA film of the lower polarizer, between the PVA film and a second TAC film of the lower polarizer, between the second TAC film and a pressure-sensitive layer of the lower polarizer or between the pressure-sensitive layer and a release film of the lower polarizer. The light-reducing film is arranged inside the upper polarizer or the lower polarizer, and thereby reducing the light transmittance of the polarizer.

The formation of the above PVA film includes dyeing and stretching processes. The PVA film is a main portion of the polarizer, also referred to as a polarization original film, and determines the polarization performance of the polarizer. The upper polarizer and the lower polarizer of the normally white liquid crystal display device have perpendicular polarities. The first TAC film and the second TAC film each are served to isolate moisture and air to protect the PVA film. The pressure-sensitive layer determines the adhesion performance and the patch processing performance of the polarizer. The release film is mainly served to protect the pressure-sensitive layer. The protective film is a polyethylene film, and an EVA layer is coated on a side of the protective film. The protective film has low adhesion performance and is served to protect the first TAC film. The light-reducing film may be arranged on a surface of one of the first TAC film, the PVA film, the second TAC film or the pressure-sensitive layer. The light-reducing film may be formed on the surface of one of these layers by way of coating and sputtering. Alternatively, the light-reducing film may be a layer of film fabricated independently, which is arranged between the layers.

The light-reducing film is arranged inside the backlight source. FIG. 3i and FIG. 3j are schematic diagrams of the normally white liquid crystal display device according to the embodiment, and the light-reducing film 11 is arranged between the diffuser plate 6 and the light guide plate 7 of the backlight source or between the light guide plate 7 and the reflection layer 8 of the backlight source.

It should be noted that, the light-reducing film is formed on the above structure of layers by way of coating or sputtering. For example, in a case that the light-reducing film is arranged between the upper polarizer and the CF substrate, a material may be formed on a surface of the upper polarizer facing the CF substrate or on a surface of the CF substrate facing the upper polarizer by way of coating or sputtering. Alternatively, the light-reducing film, as an independent film, is arranged between the upper polarizer and the CF substrate.

The normally white liquid crystal display device according to the present disclosure has a light-reducing film. In a case that no voltage is applied between the upper polarizer and the lower polarizer of the normally white liquid crystal display device and no voltage is applied on the backlight source of the normally white liquid crystal display device, light transmittances of the incident light and the reflected light are reduced due to the light-reducing film, and thereby efficiently reducing the dazzling caused by the conventional normally white liquid crystal display device. Furthermore, when the normally white liquid crystal display device operates, the backlight source emits bright light, the light-reducing film has very little influence on the light transmittance of the light emitted from the backlight source, and the dazzling is reduced although the display brightness is reduced at a certain extent. In addition, since the light transmittance of the reflected light is reduced, a display background color of the normally white liquid crystal display device tends to change from gray to black, such that the normally white liquid crystal display device looks beautiful and is easier to be accepted by most of people, and thereby broadening an application range of the normally white liquid crystal display device.

According to the above description of the disclosed embodiments, those skilled in the art can implement or practice the present disclosure. Many changes to these embodiments are apparent for those skilled in the art and general principles defined herein may be implemented in other embodiments without departing from the spirit or scope of the present disclosure. Hence, the present disclosure is not limited by the disclosed embodiments but to conform to the widest scope in accordance with principles and novelty disclosed herein.

1. A normally white liquid crystal display device, comprising a liquid crystal display and a backlight source, wherein the normally white liquid crystal display device further comprises a light-reducing film, and the light-reducing film is arranged on a surface of the liquid crystal display facing away from the backlight source, inside the liquid crystal display, between the liquid crystal display and the backlight source, or inside the backlight source.

2. The normally white liquid crystal display device according to claim 1, wherein the light-reducing film being arranged inside the liquid crystal display comprises: the light-reducing film being arranged inside an upper polarizer, between the upper polarizer and a CF substrate, between the CF substrate and a liquid crystal cell, between the liquid crystal cell and a TFT substrate, between the TFT substrate and a lower polarizer, or inside the lower polarizer.

3. The normally white liquid crystal display device according to claim 2, wherein the light-reducing film has a thickness of 0.1 μm-20 μm, inclusive of 0.1 μm and 20 μm, in a case that the light-reducing film is arranged on the surface of the liquid crystal display facing away from the backlight source, between the upper polarizer and the CF substrate, between the CF substrate and the liquid crystal cell, between the liquid crystal cell and the TFT substrate, between the TFT substrate and the lower polarizer, or between the liquid crystal display and the backlight source.

4. The normally white liquid crystal display device according to claim 2, wherein the light-reducing film has a thickness of 0.01 mm-0.50 mm, inclusive of 0.01 mm and 0.50 mm, in a case that the light-reducing film is arranged inside the upper polarizer, inside the lower polarizer, or inside the backlight source.

5. The normally white liquid crystal display device according to claim 4, wherein the light-reducing film has a thickness of 0.1 mm.

6. The normally white liquid crystal display device according to claim 4, wherein the light-reducing film being arranged inside the upper polarizer comprises: the light-reducing film being arranged between a protective film and a first TAC film of the upper polarizer, between the first TAC film and a PVA film of the upper polarizer, between the PVA film and a second TAC film of the upper polarizer, between the second TAC film and a pressure-sensitive layer of the upper polarizer, or between the pressure-sensitive layer and a release film of the upper polarizer.

7. The normally white liquid crystal display device according to claim 4, wherein the light-reducing film being arranged inside the lower polarizer comprises: the light-reducing film being arranged between a protective film and a first TAC film of the lower polarizer, between the first TAC film and a PVA film of the lower polarizer, between the PVA film and a second TAC film of the lower polarizer, between the second TAC film and a pressure-sensitive layer of the lower polarizer, or between the pressure-sensitive layer and a release film of the lower polarizer.

8. The normally white liquid crystal display device according to claim 4, wherein the light-reducing film being arranged inside the backlight source comprises: the light-reducing film being arranged between a diffuser plate and a light guide plate of the backlight source or between the light guide plate and a reflection layer of the backlight source.

9. The normally white liquid crystal display device according to claim 1, wherein the light-reducing film has a light transmittance of 10%-90%, inclusive of 10% and 90%.

10. The normally white liquid crystal display device according to claim 9, wherein the light-reducing film is a black resin film or a gray resin film.
